(19) United States
(12) Patent Application Publication
(10) Pub. No.: US 2010/0258655 A1
(43) Pub. Date: Oct. 14, 2010

(54) RAM AIR OUTLET DUCT

(76) Inventors: Alexander Solntsev, Hamburg (DE); Ruediger Schmidt, Fredenbeck (DE); Thomas Scherer, Hamburg (DE)

Correspondence Address: BARNES & THORNBURG LLP, 11 SOUTH MERIDIAN, INDIANAPOLIS, IN, 46204, US

(21) Appl. No.: 12/755,845

(22) Filed: Apr. 7, 2010

Related U.S. Application Data
(60) Provisional application No. 61/167,935, filed on Apr. 9, 2009.

(30) Foreign Application Priority Data
Apr. 9, 2009 (DE) 102009017039.1

(51) Int. Cl. B05B 1/30

(52) U.S. Cl. 239/569

(57) ABSTRACT

A ram air outlet duct (10) for removing air from an aircraft includes a ram air outlet duct wall (20) bounding an interior (16) of the ram air outlet duct (10), a ram air outlet (12), and a ram air outlet duct flap (22) for adjusting a flow cross-section of the ram air outlet (12). To minimise additional drag caused by the ram air outlet duct (10) when it is mounted in an aircraft and the aircraft is flying, a flap area of to the ram air outlet duct flap (22) is smaller than a cross-sectional area of the ram air outlet (12) and/or the ram air outlet duct wall (20) has a rounded shape in a section (26) adjoining the ram air outlet (12).

This application claims priority to U.S. Provisional Patent Application No. 61/167,935 filed Apr. 9, 2009 and German Patent Application No. 10 2009 017 039.1, filed Apr. 9, 2009, the disclosures of which are incorporated herein by reference.

The invention relates to a ram air outlet duct which serves for removing air from the interior of an aircraft to the aircraft environment. Furthermore, the invention relates to an aircraft air conditioning system equipped with such a ram air outlet duct.

A modern aircraft is equipped with a series of systems which have to be supplied with ambient air when the aircraft is flying and/or running on the ground. These systems to be supplied with ambient air include, for example, an air conditioning system serving for air conditioning of the aircraft cabin and for cooling heat-generating equipment on board the aircraft, as well as other cooling and ventilating systems which may, for example, be provided to supply ambient air to electronic components of the aircraft for cooling and/or ventilating purposes. The supply of ambient air to the systems on board the aircraft which are to be supplied with ambient air is usually carried out with the aid of a ram air duct, described, for example, in DE 10 2007 023 685 B3.

A conventional ram air duct suitable, for example, for use in an aircraft air conditioning system comprises a ram air inlet duct which can be provided, for example, with an NACA (National Advisory Committee for Aeronautics) ram air inlet arranged in the region of the aircraft outer skin. A flow cross-section of the ram air inlet and/or of a section of the ram air inlet duct arranged downstream of the ram air inlet is controlled by appropriate positioning of one or more ram air inlet duct flap(s). For actuation of the ram air inlet duct flap(s), (an) appropriately suitable actuator(s) can be used. Downstream of the ram air inlet, a diffuser is formed in the ram air inlet duct. In the diffuser, the dynamic pressure of the ambient air flow led into the ram air inlet duct via the ram air inlet is partly converted into static pressure owing to the slowing-down of the flow in the diffuser. As a result, relative to the ambient pressure, a static positive pressure, also called ram pressure, is produced in the region of an inlet of an aircraft component to be supplied with ambient air, for example of a heat exchanger arranged in the ram air duct.

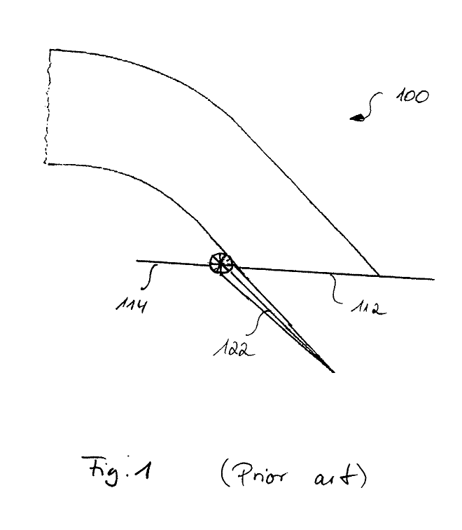

The ram air duct further comprises a ram air outlet duct 100, illustrated in FIG. 1, which serves to guide ambient air, led into the interior of the aircraft via the ram air inlet duct, back into the aircraft environment again after its utilisation on board the aircraft, for example after flowing through a heat exchanger arranged in the ram air duct. A flow cross-section of a ram air outlet 112, arranged in the region of the aircraft outer skin 114, of the ram air outlet duct 100 is controlled by appropriate positioning of a ram air outlet duct flap 122. For actuation of the ram air outlet duct flap 122, use may be made, in a manner similar to the actuation of the ram air inlet duct flap(s), of an appropriately suitable actuator.

When the aircraft is running on the ground, the ambient air is usually conveyed through the ram air duct by means of a suitable conveying device. For example, a fan of the air cycle machine (ACM) can be used to convey ambient air through the ram air duct when the aircraft is running on the ground. When the aircraft is flying, in contrast, ambient air is already flowing through the ram air duct owing to the pressure conditions in the region of the ram air inlet and the ram air outlet. The ram air inlet is preferably arranged in a region of the aircraft outer skin on which, when the aircraft is flying, a higher pressure acts than on a region of the aircraft outer skin in which the ram air outlet is positioned.

Furthermore, the pressure conditions in the region of the ram air inlet and the ram air outlet are influenced by the position of the ram air inlet duct flap(s) and the ram air outlet duct flap. For example, relative to the ambient pressure, a negative pressure is produced in the ram air outlet duct when the ram air outlet duct flap, in a position in which it opens a desired flow cross-section of the ram air outlet, projects into the ambient air flow flowing round the aircraft outer skin when the aircraft is flying. In particular, the negative pressure which builds up in the ram air outlet duct when the ram air outlet duct flap is open brings about, when the aircraft is flying, the production of a differential pressure between the ram air inlet and the ram air outlet and consequently the conveyance of ambient air through the ram air duct and, for example, a heat exchanger arranged in the ram air duct.

The further the ram air outlet duct flap projects into the ambient air flow flowing round the aircraft outer skin when the aircraft is flying, the greater the difference between the ambient pressure and the pressure in the ram air outlet duct becomes. To convey a large ambient air mass flow through the ram air outlet duct, it is therefore favourable for the ram air outlet duct flap to project as far as possible into the ambient air flow flowing round the aircraft outer skin when the aircraft is flying. Furthermore, a ram air outlet duct flap projecting far into the ambient air flow flowing round the aircraft outer skin when the aircraft is flying opens a large flow cross-section of the ram air outlet. As a result, a resistance of the ram air outlet duct opposing the flow of ambient air through the ram air duct is minimised.

Taking these influencing factors into account, the ambient air mass flow through the ram air duct can thus be controlled by appropriate positioning of the ram air inlet duct flap(s) and/or the ram air outlet duct flap. For example, the ambient air mass to flow through the ram air duct can be increased by opening the ram air inlet duct flap(s) and/or the ram air outlet duct flap when a regulating temperature, for example a temperature of a component of the aircraft air conditioning system detected by means of a suitable sensor, exceeds a predetermined threshold value. Similarly, the ambient air mass flow through the ram air duct can be decreased by closing the ram air inlet duct flap(s) and/or the ram air outlet duct flap when the regulating temperature falls below a predetermined threshold value.

Since the opening of the ram air outlet duct flap increases the drag and thus the fuel consumption of the aircraft owing to the fact that the flap in the open state projects from the aircraft outer skin, a position of the flap as far as possible closed should always be sought in the control of the ambient air mass flow through the ram air duct. Recent investigations have additionally shown that an open ram air outlet duct flap produces higher additional drag than (an) open ram air inlet duct flap(s). In order to ensure a sufficient ambient air mass flow through the ram air duct, however, in normal operation of conventionally designed ram air ducts, it is generally not possible to avoid relatively wide opening of the ram air outlet duct flap, i.e. positioning thereof with an inclination at an angle of >10° relative to an aircraft outer skin section surrounding the ram air outlet. Furthermore, the ram air outlet duct flap projecting into the ambient air flow flowing round the aircraft skin when the aircraft is flying and also separations of the air flow exiting from the ram air outlet cause turbulence in the ambient air flow flowing round the aircraft outer skin when the aircraft is flying, which further increases the additional drag of the aircraft caused by the ram air duct.

The invention is directed to the object to provide a ram air outlet duct, intended for use in an aircraft, which causes a low additional drag of the aircraft when the aircraft is flying. Furthermore, the invention is directed to the object to specify an air conditioning system equipped with such a ram air outlet duct.

This object is achieved by a ram air outlet duct having the features of claim 1 and an air conditioning system having the features of claim 6.

A ram air outlet duct, according to the invention, for removing air from an aircraft comprises a ram air outlet duct wall bounding an interior of the ram air outlet duct, and a ram air outlet which, when the ram air outlet duct is mounted in an aircraft, is arranged in the region of an aircraft outer skin and thereby connects the interior of the ram air outlet duct to the aircraft environment. The ram air outlet duct can serve, for example, to guide “used” cooling air back into the aircraft environment. A ram air outlet duct flap serves to adjust a flow cross-section of the ram air outlet. The ram air outlet duct flap may be designed, for example, in the form of a flap pivotable about an axis. When the ram air outlet duct flap is in a closed position, it minimises the through-flow cross-section of the ram air outlet. The further the ram air outlet duct flap is opened, i.e. the further the ram air outlet duct flap is inclined relative to a section of the aircraft outer skin surrounding the ram air outlet, the greater the through-flow cross-section of the ram air outlet becomes. Furthermore, the difference between the reduced pressure in the interior of the ram air outlet duct and the ambient pressure increases with an increasing opening angle of the ram air outlet duct flap when an aircraft equipped with the ram air outlet duct according to the invention is flying.

To minimise the additional drag caused by the ram air outlet duct when it is mounted in an aircraft and the aircraft is flying, a flap area of the ram air outlet duct flap is smaller than a cross-sectional area of the ram air outlet. Additionally or alternatively thereto, the ram air outlet duct wall has a rounded shape in a section adjoining the ram air outlet. By minimising the additional drag caused by the ram air outlet duct according to the invention when it is mounted in an aircraft and the aircraft is flying, the fuel consumption of an aircraft equipped with the ram air outlet duct according to the invention can be advantageously reduced.

A ram air outlet duct flap, the flap area of which is smaller than the cross-sectional area of the ram air outlet, does not completely cover the cross-sectional area of the ram air outlet even in its closed position. A ram air outlet duct provided with such a ram air outlet duct flap is distinguished by the fact that it has a low ram air outlet duct drag even with small opening angles of the ram air outlet duct flap, i.e. even when the ram air outlet duct flap is positioned with only a slight inclination relative to the aircraft outer skin section surrounding the ram air outlet. In other words, the ram air outlet duct enables a comparatively unobstructed outflow of air from the ram air outlet even with small opening angles of the ram air outlet duct flap. Furthermore, a ram air outlet duct flap with a reduced flap area produces a reduced additional drag in its open position, i.e. when the ram air outlet duct flap projects into the air flow flowing round the aircraft outer skin when the aircraft is flying.

A ram air outlet duct wall having a rounded shape in a section adjoining the ram air outlet is aerodynamically optimised and leads the air out of the ram air outlet duct, smoothly and without separations, into the air flow flowing round the aircraft outer skin when the aircraft is flying. As a result, the production of turbulence in the air flow flowing round the aircraft outer skin when the aircraft is flying, which gives rise to a further increase of the additional drag of the aircraft caused by the ram air outlet duct, is avoided.

In principle, the ram air outlet duct according to the invention can be provided only with a ram air outlet duct flap designed as described above or only with a ram air outlet duct wall section of rounded shape and thus aerodynamically optimised. However, a particularly low additional drag is produced by a ram air outlet duct which has both a ram air outlet duct flap designed as described above and a ram air outlet duct wall section of rounded shape and thus aerodynamically optimised. The combination of a ram air outlet duct flap, the flap area of which is smaller than the cross-sectional area of the ram air outlet, with a ram air outlet duct wall section of rounded shape and adjoining the ram air outlet has a superproportional effect with regard to the reduction of the ram air outlet duct drag, in particular with small opening angles of the ram air outlet duct flap. In other words, particularly with small opening angles of the ram air outlet duct flap, the ram air outlet duct drag of a ram air outlet duct which has a ram air outlet duct flap designed as described above and a ram air outlet duct wall section of rounded shape is markedly reduced compared with conventional ram air outlet ducts. This has a positive effect on the value of the negative pressure at the interface between the ram air outlet duct and an air conditioning system. This allows the throughput of the required amount of cooling air with smaller opening angles of the ram air outlet duct flap. This surprising effect of the combination of a ram air outlet duct flap designed as described above with a ram air outlet duct wall section of rounded shape enables operation of the ram air outlet duct with extremely small ram air outlet duct flap angles of down to 0° when the aircraft is flying normally. As a result, significant fuel savings can be achieved in the operation of an aircraft equipped with the ram air outlet duct according to the invention.

In a preferred embodiment of the ram air outlet duct according to the invention, the flap area of the ram air outlet duct flap occupies 40 to 80% of the cross-sectional area of the ram air outlet.

Compared with a conventional ram air outlet duct flap, a ram air outlet duct flap, the flap area of which is smaller than the cross-sectional area of the ram air outlet, produces a smaller difference between the reduced pressure in the interior of the ram air outlet duct and the ambient pressure, with a preset opening angle and with preset flow conditions in the ram air outlet duct. In the ram air outlet duct according to the invention, this pressure difference can be increased, if required, by increasing the opening angle of the ram air outlet duct flap. In the ram air outlet duct according to the invention therefore, a maximum angle at which the ram air outlet duct flap is positionable, when the ram air outlet duct is mounted in an aircraft, relative to the section of the aircraft outer skin surrounding the ram air outlet, i.e. the maximum opening angle of the ram air outlet duct flap, is preferably adapted to a difference, between the ambient pressure and the pressure in the ram air outlet duct, which arises when the ram air outlet duct flap is positioned at a predetermined angle relative to the section of the aircraft outer skin surrounding the ram air outlet. In other words, for the ram air outlet duct flap a larger maximum opening angle is provided, the smaller the pressure difference, between the ambient pressure and the pressure in the ram air outlet duct, producible by the ram air outlet duct flap with a predetermined opening angle, for example the maximum opening angle.

For example, the ram air outlet duct flap can be positionable at an angle of up to 60° relative to the section of the aircraft skin surrounding the ram air outlet.

If the ram air outlet duct wall of the ram air outlet duct according to the invention has a rounded shape at the section adjoining the ram air outlet, preferably only a tail-side region of the ram air outlet duct wall is of rounded shape in a section adjoining the ram air outlet and thus aerodynamically optimised. Such a configuration of the ram air outlet duct wall enables a particularly favourable flow guidance which allows a smooth and separation-free outflow of the air from the ram air outlet into the air flow flowing round the aircraft outer skin when the aircraft is flying.

An aerodynamically particularly favourable form of the ram air outlet duct wall is obtained when the ram air outlet duct wall is arched in the direction of the interior of the ram air outlet duct. In other words, the ram air outlet duct wall of the ram air outlet according to the invention preferably has a tail-side section, adjoining the ram air outlet, which is designed in the form of a ramp which, in the direction of the air flow through the ram air outlet duct, initially has an increasing and subsequently a decreasing gradient. As a result of a ramp formed in this way, the air flowing through the ram air outlet duct is, already on flowing through the ram air outlet duct, directed in a direction which is adapted to the flow direction of the air flow flowing round the aircraft outer skin when the aircraft is flying. In other words, the ramp redirects the air flowing through the ram air outlet duct in such a way that the angle of inclination of the flow direction of the air on exiting from the ram air outlet duct relative to the flow direction of the air flow flowing round the aircraft outer skin when the aircraft is flying is minimised.

The ram air outlet duct according to the invention can be used, in various systems on board an aircraft which serve, for example, for cooling and/or ventilation of different aircraft components, for the supply of ambient air to these systems. However, the ram air outlet duct according to the invention is particularly well suited to use in an aircraft air conditioning system. For example, the ram air outlet duct according to the invention can serve to remove ambient air, supplied to one or more heat exchanger(s) of the aircraft air conditioning system, to the aircraft environment after flowing through the heat exchanger(s).

A preferred embodiment of the invention will now be explained in more detail with the aid of the appended schematic figures, of which

FIG. 1 shows a cross-sectional view of a ram air outlet duct known from the prior art, and

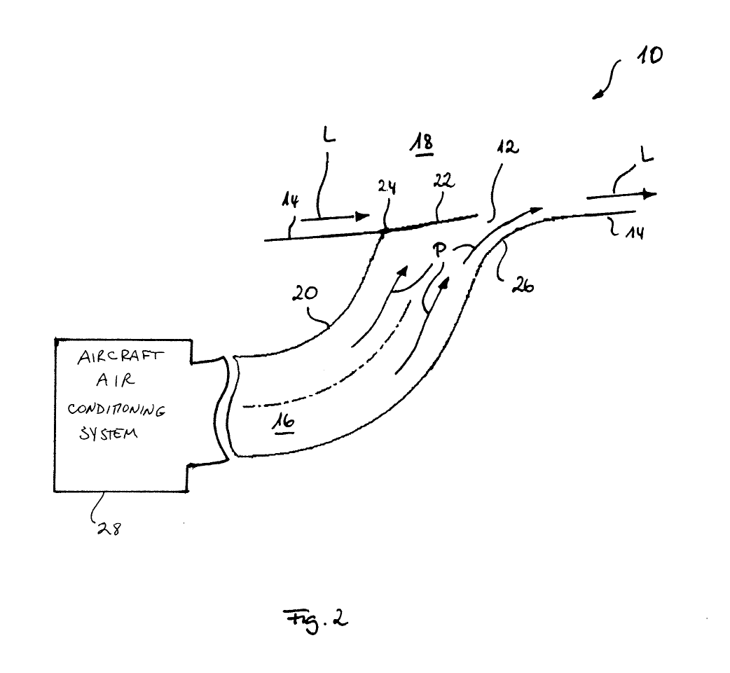

FIG. 2 shows a cross-sectional view of a ram air outlet duct according to the invention.

FIG. 2 shows a ram air outlet duct 10 which is provided for use in an aircraft air conditioning system and serves to remove ambient air, supplied to heat exchangers of the aircraft air conditioning system, to the aircraft environment after flowing through the heat exchangers. The ram air outlet duct 10 has a ram air outlet 12 which, when the ram air outlet duct 10 is mounted in an aircraft, as illustrated in the figure, is formed in an aircraft outer skin 14. The ram air outlet 12 thus connects an interior 16 of the ram air outlet duct 10 to an aircraft environment 18. The interior 16 of the ram air outlet duct 10 is bounded by a ram air outlet duct wall 20.

To adjust a flow cross-section of the ram air outlet 12, the ram air outlet duct 10 is provided with a ram air outlet duct flap 22. The ram air outlet duct flap 22 is pivotable about an axis 24 arranged adjacent to a nose-side section of the cross-sectional area of the ram air outlet 12. A flap area of the ram air outlet duct flap is smaller than the cross-sectional area of the ram air outlet 12, so that the ram air outlet duct flap 22, even in its closed position, opens a tail-side section of the ram air outlet cross-sectional area.

Since the ram air outlet duct flap 22, owing to its reduced flap area compared with a conventional ram air outlet duct flap, can produce merely a smaller pressure difference between the reduced pressure in the interior 16 of the ram air outlet duct 10 and the ambient pressure, a maximum opening angle of the ram air outlet duct flap 22 is adapted to the pressure difference, dependent on the flap area, which arises when the ram air outlet duct flap 22 is positioned at a predetermined angle, for example the maximum opening angle relative to a section of the aircraft outer skin 14 surrounding the ram air outlet 12. In other words, the maximum opening angle of the ram air outlet duct flap 22 is chosen to be large enough to be able to set a sufficiently large pressure difference between the pressure in the interior 16 of the ram air outlet duct 10 and the ambient pressure in all operating states of the ram air outlet duct 10. In the exemplary embodiment shown in the figure, the maximum opening angle of the ram air outlet duct flap 22 is 45°.

As is further evident in FIG. 2, the ram air outlet duct wall 20 has a rounded shape in a tail-side section 26 adjoining the ram air outlet 12. In particular, the ram air outlet duct wall 20 is arched in the section 26 in the direction of the interior 16 of the ram air outlet duct 10 and thereby forms a ramp which, in the direction of the air flow through the ram air outlet duct 10, arrow P, initially has an increasing and subsequently a decreasing gradient. The ram air outlet duct 10 is further illustrated in FIG. 2 as fluidly coupled to, and provided for use in, an otherwise conventional aircraft air conditioning system 28.

Compared with a conventional ram air outlet duct flap, the ram air outlet duct flap 22, owing to its reduced flap area, causes a reduced drag when the aircraft is flying with the same opening angles. Furthermore, as a result of the reduced flap area of the ram air outlet duct flap 22, in particular combined with the ram air outlet duct wall 20 of rounded form, the drag of the ram air outlet duct is reduced. This has a positive effect on the value of the negative pressure at the interface between the ram air outlet duct and an air conditioning system. This allows the throughput of the required amount of cooling air with smaller opening angles of the ram air outlet duct flap. As a result, the ram air outlet duct 10 can be operated with extremely small opening angles of the ram air outlet duct flap 22 of down to 0° when the aircraft is flying normally, without the air mass flow through the ram air outlet duct 10 becoming too low. Finally, the ram air outlet duct wall section 26 of rounded shape enables, as a result of its aerodynamically optimised form, a smooth and separation-free discharge of the air from the ram air outlet duct 10 into an air flow L flowing round the aircraft outer skin 14 when the aircraft is flying. The ram air outlet duct 10 thus enables minimisation of the additional drag produced by the ram air outlet duct 10 and consequently of the fuel consumption of the aircraft.

1. A ram air outlet duct for removing air from an aircraft, comprising:
a ram air outlet duct wall bounding an interior of the ram air outlet duct,
a ram air outlet, and
a ram air outlet duct flap for adjusting a flow cross-section of the ram air outlet,
characterised in that, to minimise additional drag caused by the ram air outlet duct when it is mounted in an aircraft and the aircraft is flying, at least one of a flap area of the ram air outlet duct flap is smaller than a cross-sectional area of the ram air outlet and the ram air outlet duct wall has a rounded shape in a section adjoining the ram air outlet.

2. The ram air outlet duct according to claim 1, characterised in that the ram air outlet duct flap is adapted to close, in its closed position, a nose-side section of the cross-sectional area of the ram air outlet.

3. The ram air outlet duct according to claim 1, characterised in that a maximum angle at which the ram air outlet duct flap is positionable, when the ram air outlet duct is mounted in an aircraft, relative to a section of an aircraft outer skin surrounding the ram air outlet is adapted to a difference, between ambient pressure and pressure in the ram air outlet duct, which arises when the ram air outlet duct flap is positioned at a predetermined angle relative to the section of the aircraft outer skin surrounding the ram air outlet.

4. The ram air outlet duct according to claim 1, characterised in that a tail-side region of the ram air outlet duct wall has the rounded shape in the section adjoining the ram air outlet.

5. The ram air outlet duct according to claim 1, characterised in that the ram air outlet duct wall has a shape arched in the direction of the interior of the ram air outlet duct.

6. An aircraft air conditioning system, characterised by the ram air outlet duct according to any of claims 1-5.
